(19) United States
(12) Patent Application Publication
(10) Pub. No.: US 2008/0124203 A1
(43) Pub. Date: May 29, 2008

(54) INTEGRATED VEHICLE DOCKING SYSTEM AND RELATED METHOD

(75) Inventor: Daniel R. McDONALD, South Lyon, MI (US)

Correspondence Address: HARNESS, DICKEY & PIERCE, P.L.C., P.O. BOX 828, BLOOMFIELD HILLS, MI, 48303, US

(73) Assignee: ADVANCED SYSTEMS, INC., Clawson, MI (US)

(21) Appl. No.: 11/934,158

(22) Filed: Nov. 2, 2007

Related U.S. Application Data
(63) Continuation-in-part of application No. 11/189,401, filed on Jul. 26, 2005.

(51) Int. Cl. B65G 69/28

(52) U.S. Cl. 414/401; 414/809

(57) ABSTRACT

The present invention generally includes a method for controlling a vehicle docking system that receives a vehicle at a loading dock. The method includes detecting an undercarriage of the vehicle and determining whether the vehicle is restrained based on the detection. The method further enables operation of a door based the determination. The door is adapted to permit access to the loading dock.

### CROSS-REFERENCE TO RELATED APPLICATIONS

This application is a continuation-in-part of U.S. patent application Ser. No. 11/189,401, filed on 26 Jul. 2005 entitled INTEGRATED VEHICLE DOCKING SYSTEM AND RELATED METHOD. The application was published on 9 Mar. 2006 as Publication No. US 2006/0051196 A1. The disclosure of the above application is hereby incorporated by reference as if fully set forth herein.

### FIELD

The present teachings generally relate to vehicle docking systems. More particularly, the present teachings relate to an integrated vehicle docking system for controlling operation of an associated dock in response to the presence or absence of predetermined conditions. The present teachings also pertain to a related method.

### BACKGROUND

Loading docks have long been used to facilitate the delivery to and shipment from commercial buildings. Many known loading docks incorporate power driven systems for controlling the opening and closing of an overhead door. Such power driven systems eliminate the inconvenience otherwise associated with exiting a vehicle every time opening or closing of the overhead door is necessary.

Door systems conventionally incorporate safety features to prevent closing of the door during the presence of an obstacle. In a common manner, current door systems incorporate, among other safety features, electronic eyes at laterally opposing sides of the door opening near a lower portion of the opening. When an imaginary line between the cooperating eyes is broken by an obstacle, downward motion of the door is reversed.

When a door system is used in conjunction with a vehicle loading dock, additional safety measures are required. In this regard, it is important to determine when a vehicle (i.e., trailer) is suitably chocked in the dock area. Most of these systems require human inputs to assess certain system aspects (e.g., whether the vehicle is properly chocked). Such systems are often easily circumvented. Furthermore, such systems allow for the introduction of human error which may be innocent but nevertheless critical. Other known systems do not suitably function in the event of sensor failures.

There remains a need in the pertinent art to continuously improve vehicle docking systems for both efficiency and safety.

### SUMMARY

The present teachings generally include a method for controlling a vehicle docking system that receives a vehicle at a loading dock. The method includes detecting an undercarriage of the vehicle and determining whether the vehicle is restrained based on the detection. The method further enables operation of a door based the determination. The door is adapted to permit access to the loading dock.

Further areas of applicability of the present teachings will become apparent from the detailed description provided hereinafter. It should be understood that the detailed description and specific examples indicate various embodiments of the invention, which are intended for purposes of illustration only and not intended to limit the scope of the invention.

### BRIEF DESCRIPTION OF THE DRAWINGS

The present invention will become more fully understood from the detailed description, the appended claims and the accompanying drawings, wherein:

FIG. 1 is a front view (from the outside) of an integrated vehicle docking system constructed in accordance with the present teachings, the integrated vehicle docking system shown operatively associated with a loading dock;

FIG. 2 is perspective view of the integrated vehicle docking system of FIG. 1, the integrated vehicle docking system shown operatively associated with a pair of loading docks, a vehicle and a vehicle trailer shown secured at a first of the loading docks;

FIG. 3 is a simplified schematic view of the integrated vehicle docking system constructed in accordance with the present teachings;

FIGS. 4 through 8 are various electrical schematics of the integrated vehicle docking system in accordance with the present teachings;

FIG. 9 is a schematic view of the integrated vehicle docking system in accordance with the present teachings; and

FIGS. 10A through 10H are flowcharts of an exemplary control system of the integrated vehicle docking system in accordance with the present teachings.

FIG. 11 is a perspective view of a trailer jack for use with a docking system in accordance with the present teachings, the trailer jack shown operatively associated with a vehicle trailer 14.

FIG. 12 is another perspective view of the trailer jack of FIG. 11, the trailer jack removed from the environment of FIG. 11 for purposes of illustration.

### DESCRIPTION OF VARIOUS FEATURES

The following description of the various embodiments of the present teachings is merely exemplary in nature and are in no way intended to limit the invention, its application or uses. As used herein, the term module may refers to (or be a portion of) an application specific integrated circuit (ASIC), an electronic circuit, a processor (shared, dedicated, or group) and memory that executes one or more software or firmware programs, a combinational logic circuit, a programmable logic controller or other suitable components that provide the described functionality. Moreover, certain connections between modules, components etc. may be illustrated but various connection configurations may implement the present teachings.

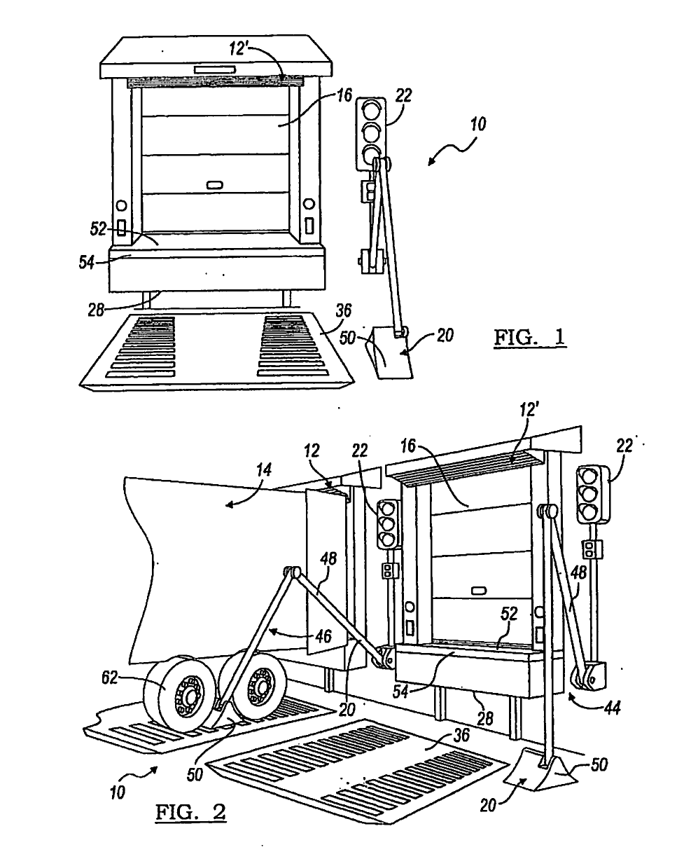

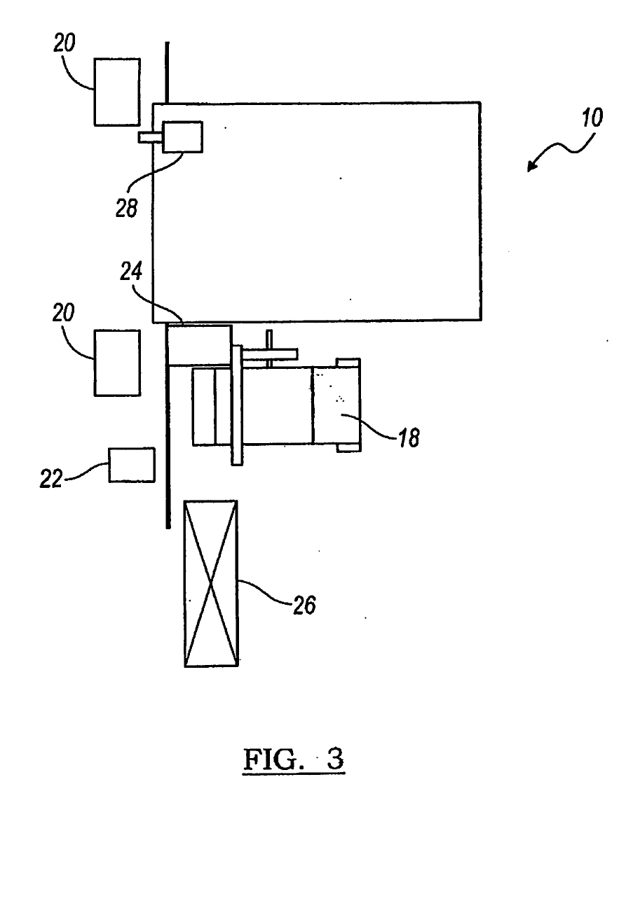

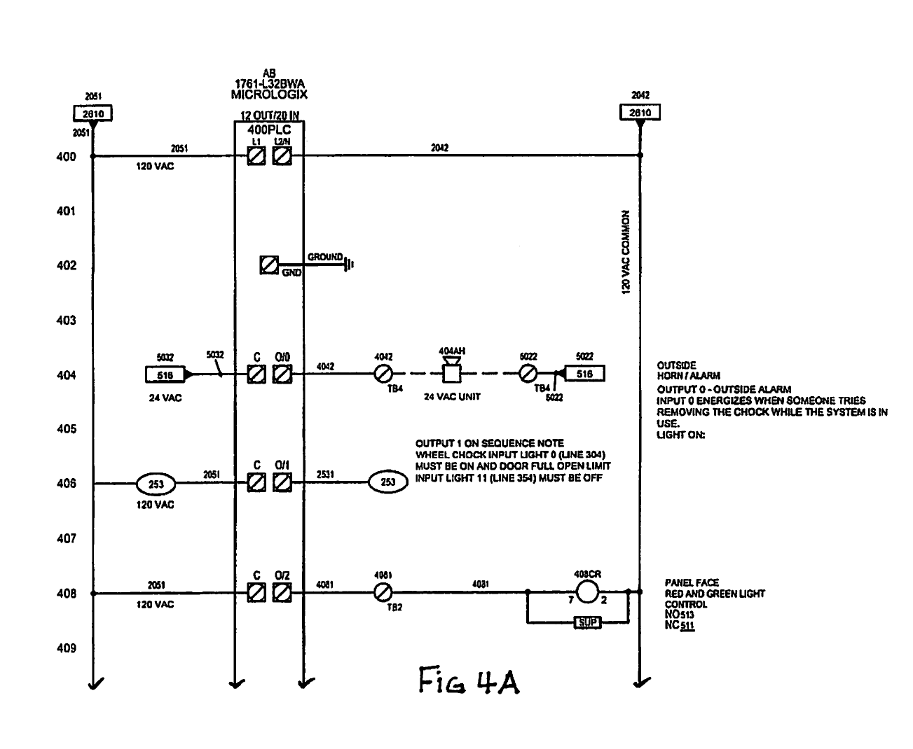

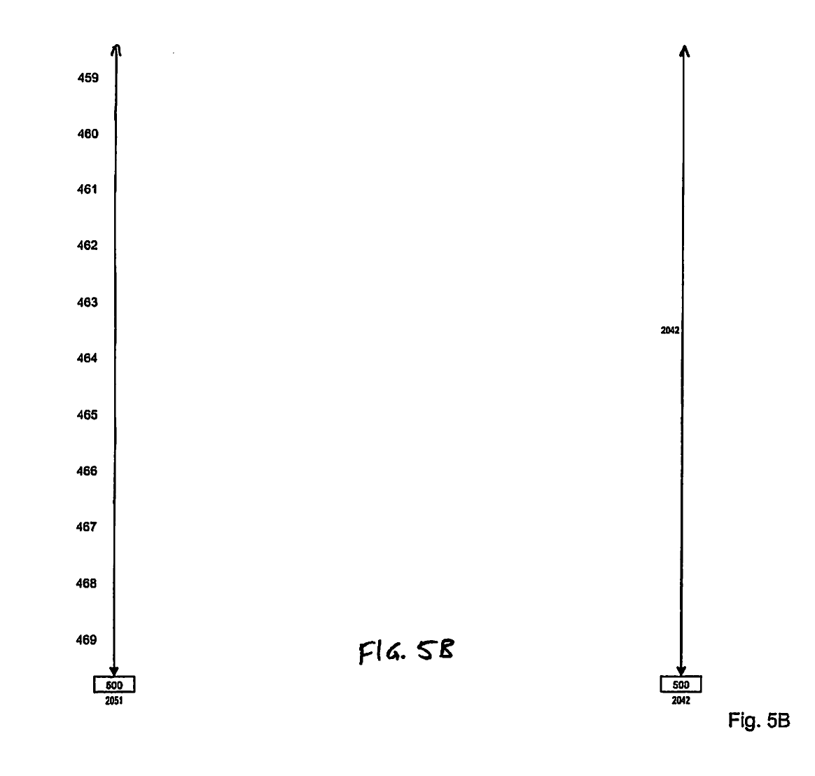

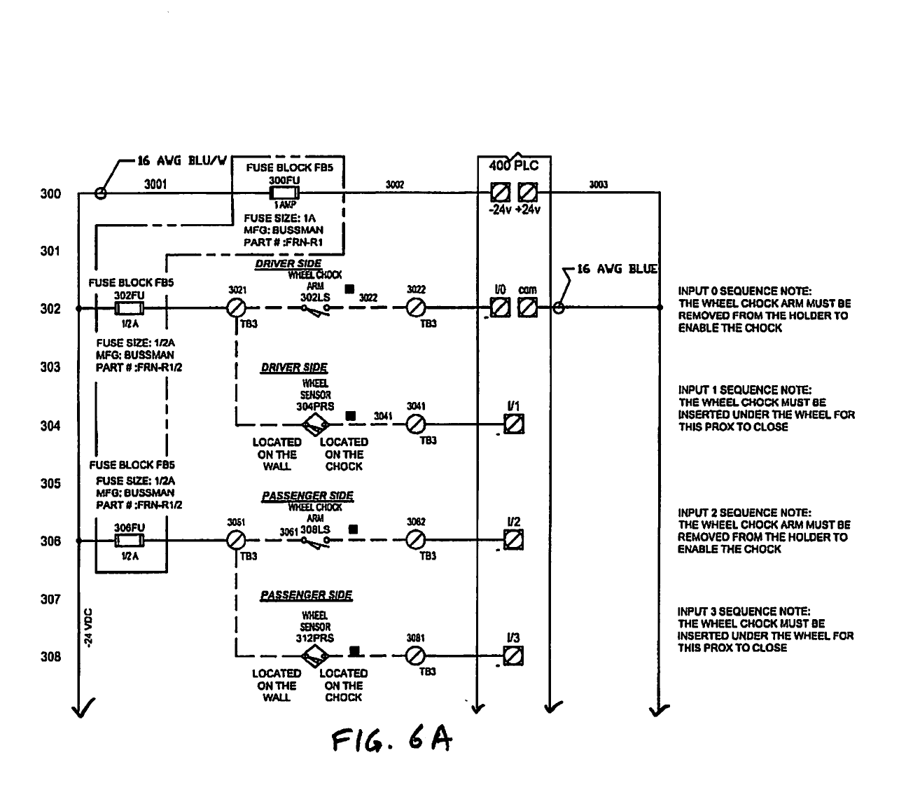

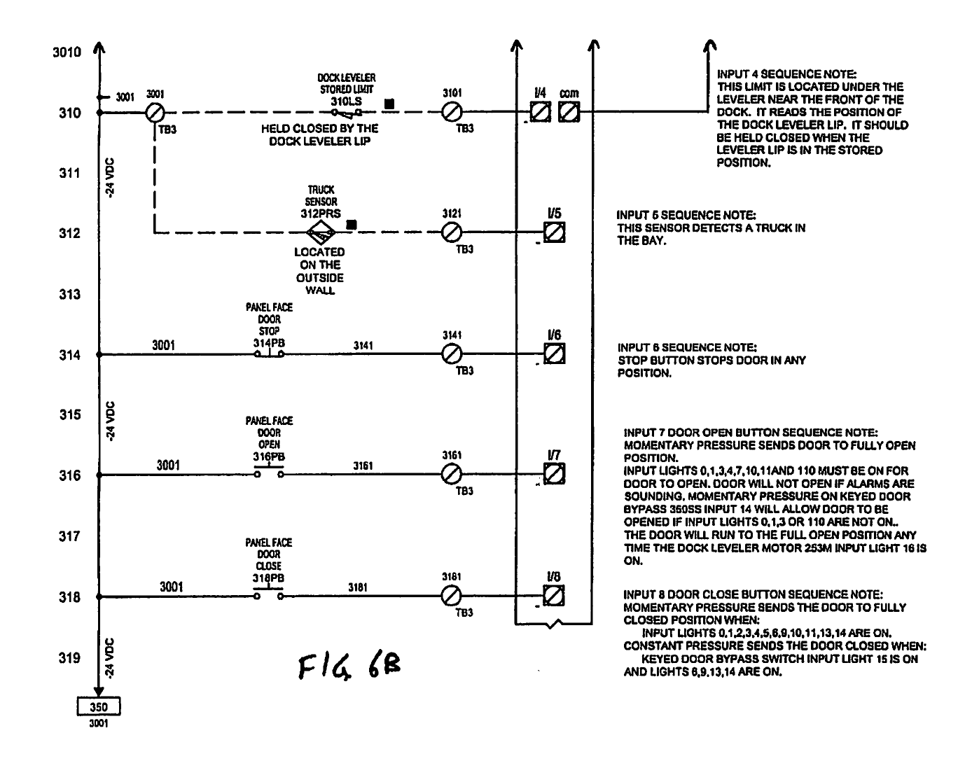

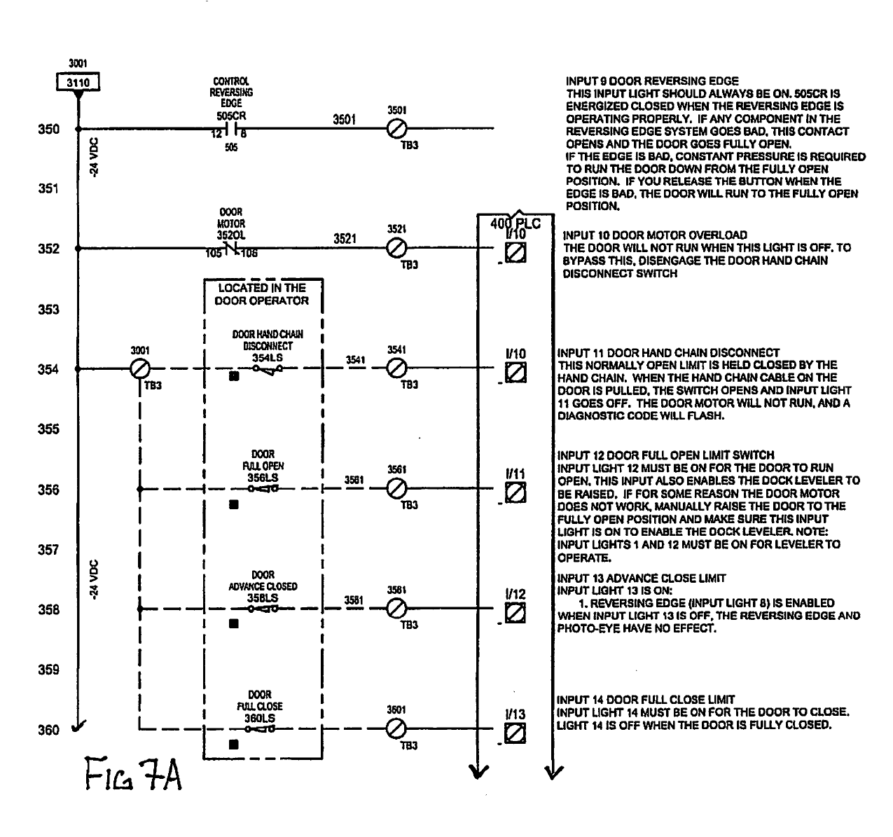

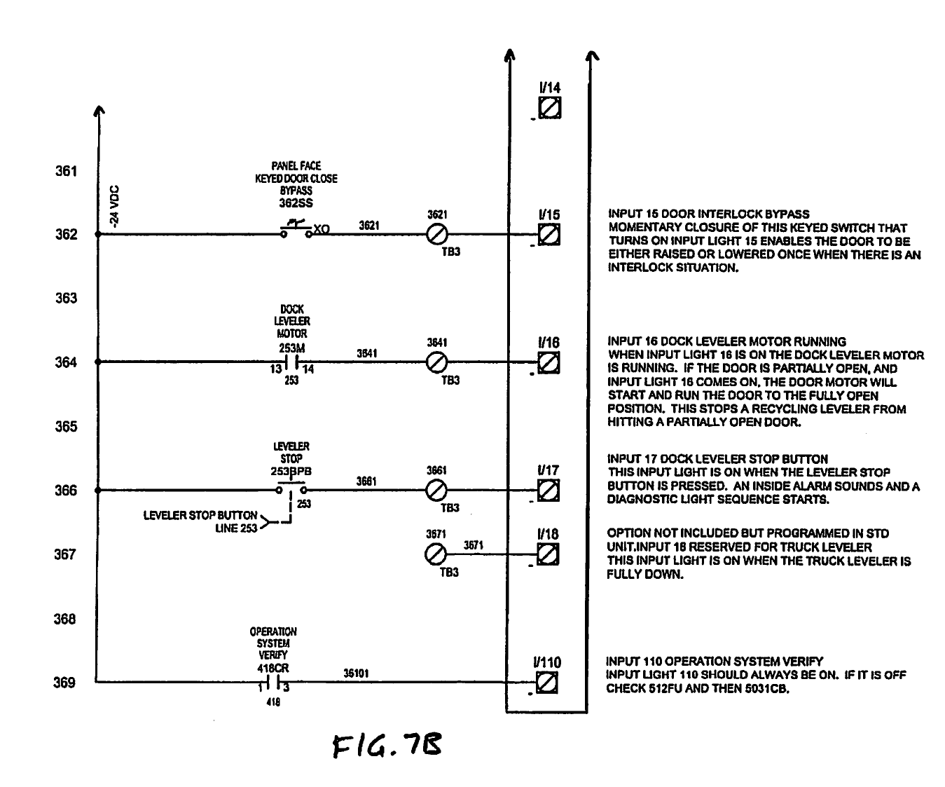

With reference to FIGS. 1 through 8 of the drawings, an integrated vehicle docking system in accordance with the teachings of the present teachings is illustrated and generally identified at reference character 10. FIGS. 1 and 3 show the docking system 10 associated with a first loading dock 12. For purposes of illustration, FIG. 2 additionally shows the docking system 10 associated with a second loading dock 12′. A vehicle and a vehicle trailer 14 is shown located and secured at the first loading dock 12.

The docking system 10 of the present teachings is shown to generally include an overhead door 16, a door operator 18, and one or more vehicle restraints 20. The docking system 10 is additionally shown to generally include an outside light unit 22 and an inside light unit 24. The docking system 10 is further shown to generally include a control panel 26 and a dock leveler 28.

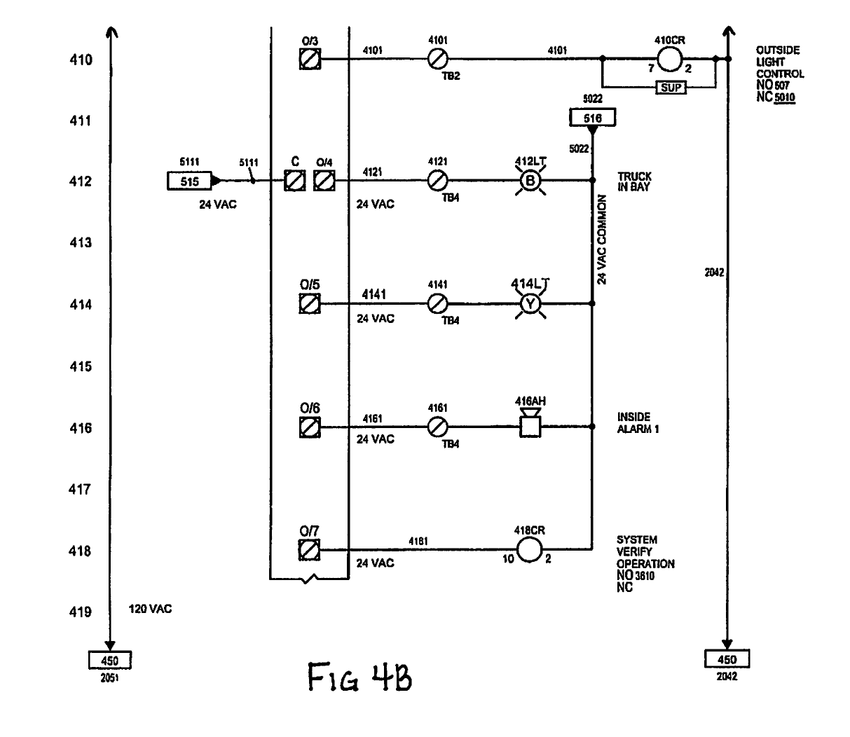

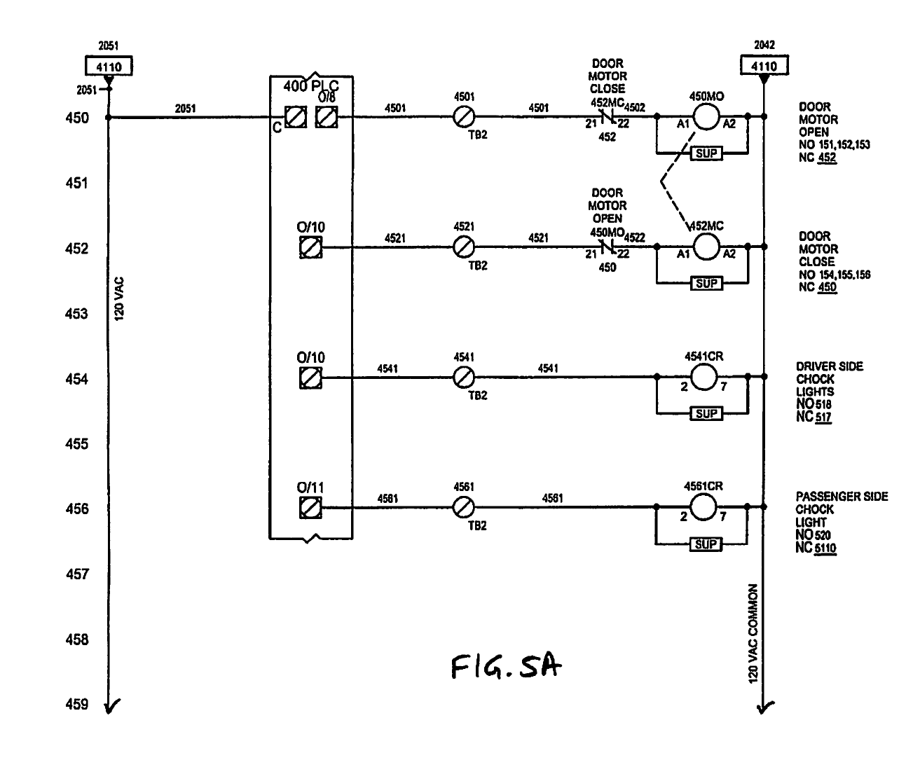

In one example, the control panel 26 and/or a control module 30 can be PLC driven rather than relay logic driven. The control panel 26 can be readily adapted for use with virtually any brand of equipment and can control items including, but not limited to dock levelers, trailer levelers, overhead doors, vehicle restraints, inflatable shelters, and door heaters. Control of these and potentially other items can be accomplished in a predetermined sequence. The operation of the system 10 can be the same, regardless of the equipment selected. Because the control panel 26 is PLC driven, there are sensors throughout the system 10 to identify predetermined conditions and failures. If one or more of the sensors fails, the control panel 26 and/or the control module 30 prohibits progression to the next step (and an amber interior light is activated). FIGS. 4 through 8 illustrate various electrical schematics of the integrated vehicle docking system 10 of one particular embodiment of the present invention.

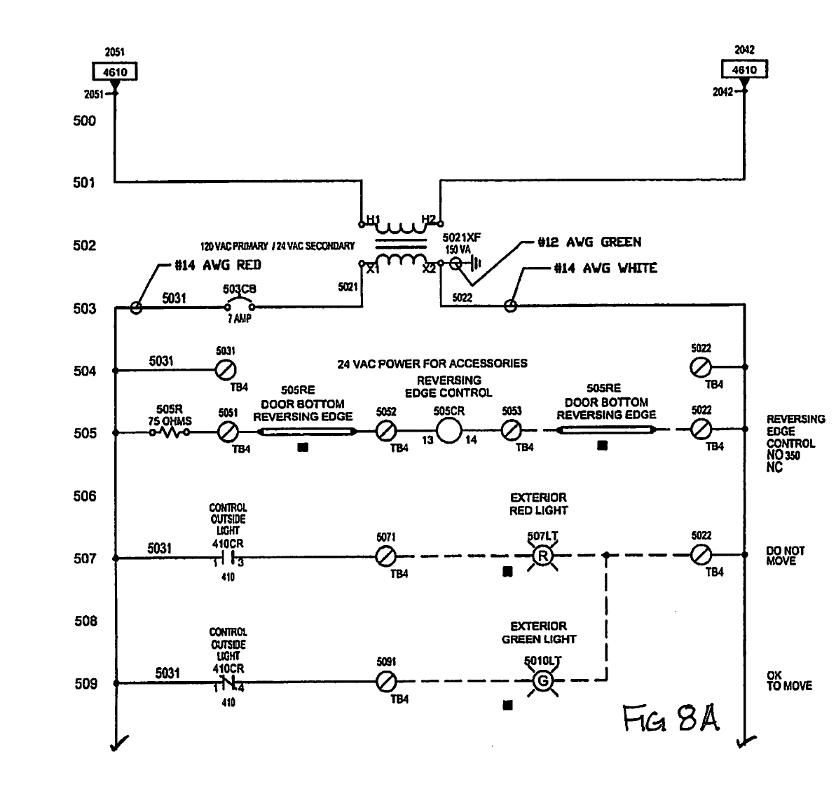

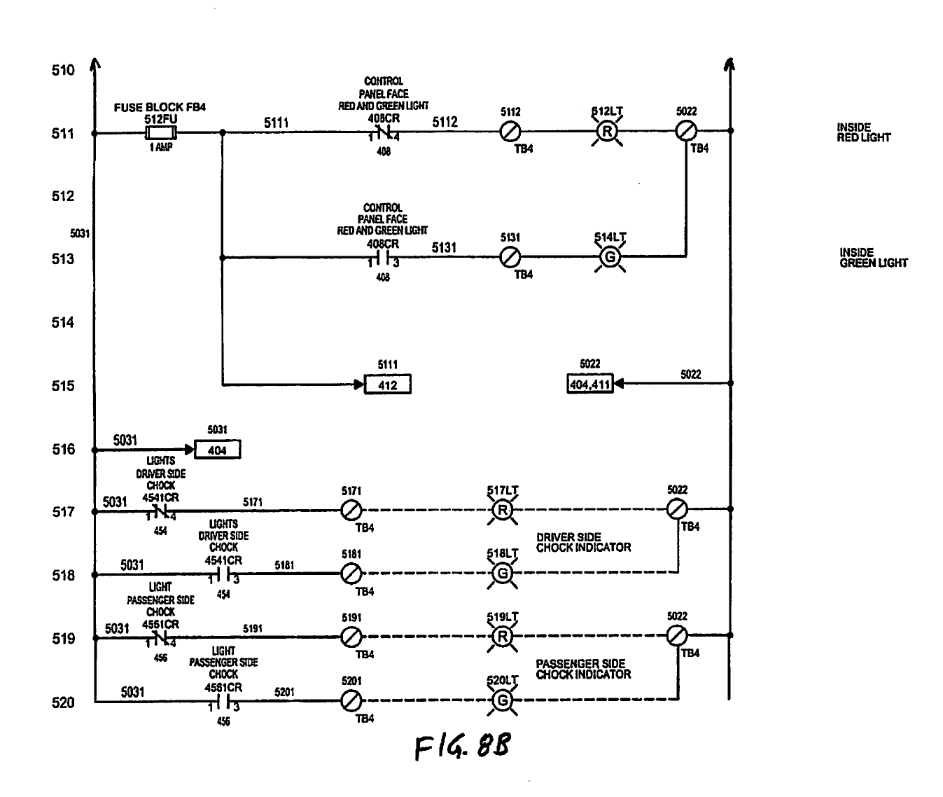

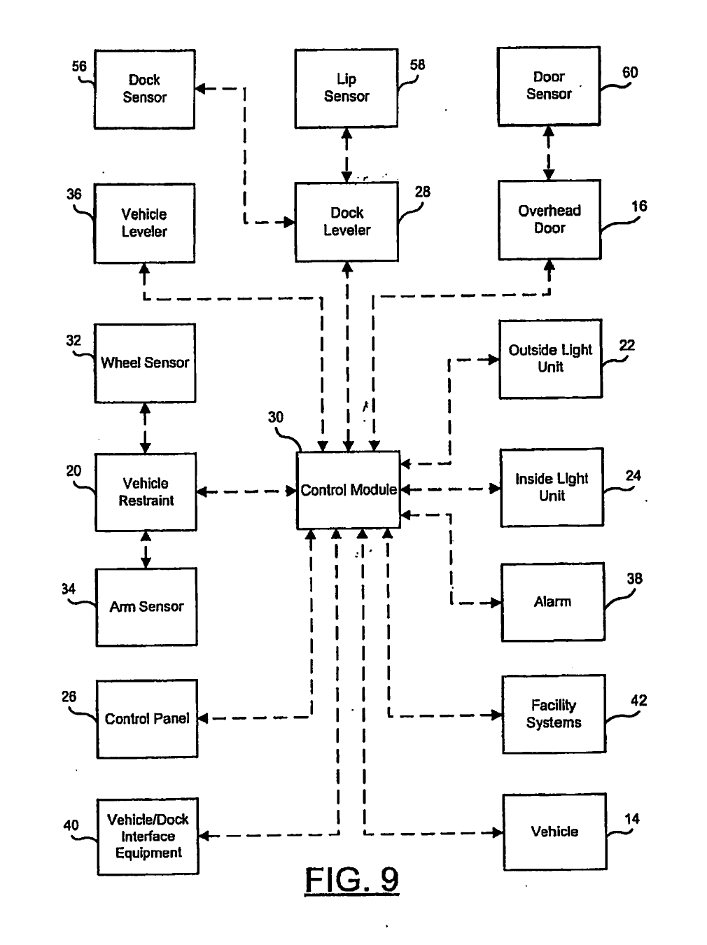

In one example and with reference to FIG. 9, the control module 30 can be connected to one or more vehicle restraints 20. The vehicle restraints 20 can be connected to a wheel sensor 32 and an arm sensor 34. The control module 30 can be also connected to the overhead door 16, the dock leveler 28, and a vehicle leveler 36. The control module 30 can be also connected to the outside light unit 22, an inside light unit 24 and an alarm 38. The control module 30 can be further connected to the control panel 26, vehicle/dock interface equipment 40 and facility systems 42. The facility systems 42 may include, for example, a security system, a maintenance system, a heating and cooling system, other suitable facility systems and combinations thereof. The vehicle/dock interface equipment 40 may include, for example, inflatable shelters, door heaters, additional lighting, barricades, other suitable systems and combinations thereof.

The control module 30 can be further connected to the vehicle 14. It will be appreciated that the control module 30 can communicate to one or more components using various forms of electromagnetic wave communication which can be a direct (i.e., wired) or an indirect connection (i.e., wireless). Some forms of indirect connection may include the internet or other computer interface. It will also be appreciated that all of the above said components are not required to implement the integrated vehicle docking system 10. For example, the control module 30 need not be connected to vehicle 14. In other examples, the following need not be used: the vehicle leveler 36, connection to facility system 42 and/or certain vehicle/dock interface equipment 40. In a further example, the control panel 26 and the control module 30 may embody a single unit or may be remote from one another.

With reference to FIGS. 1 and 2, the vehicle restraint 20 functions to minimize unsafe dock loading and unloading conditions such as premature departure, creeping and tipping. Several types of vehicle restraints are commercially available. One suitable vehicle restraint is commercially available from GMR Safety, Inc. under the trademark Power Chock™. As most clearly shown in the environmental view of FIG. 2, the vehicle restraint 20 is movable from a stored or home position 44 (as shown in connection with the second loading dock 12′) to a deployed or restrained position 46 (as shown in connection with the first loading dock 12). This much of the vehicle restraint 20 will be understood to be conventional insofar as the present invention is concerned. The vehicle 14 is shown restrained by a single vehicle restraint 20 on the driver's side. It will be appreciated by those skilled in the art that the vehicle 14 may be restrained at the driver's side, at the passenger's side, or both.

With reference to FIGS. 1, 2, 3 and 9, the vehicle restraint 20 cooperates with a first sensor or the arm sensor 34 and a second or a wheel sensor 32 for indicating the operational status of the vehicle restraint 20. In this regard, a first sensor 34 (not schematically shown in FIGS. 4-8) is associated with an arm 48 of the vehicle restraint and operates to send a signal to the control panel 26 and/or the control module 30 indicating the vehicle restraint 20 is in its stored position 44. When in the stored position 44, the control panel 26 and/or control module 30 functions to illuminate a red light of the inside light unit 24 and a green light of the outside light unit 22.

The second sensor or the wheel sensor 32 (schematically shown in FIGS. 4-8) is associated with a restraint portion 50 (e.g. a chock) of the vehicle restraint 20. The second sensor 32 operates to send a signal to the control panel 26 and/or the control module 30 indicating that the vehicle restraint 20 is in the deployed position 46. When in the deployed position 46, the control module 30 can enable the door 16 for operation, as explained below, and further functions to turn off the green light and turn on the red light in the outside light unit 22. It will be appreciated that the outside light unit 22 and/or the inside light unit 24 may contain a single light that may be adjusted to one or more colors, multiple lights having multiple colors and/or combinations thereof.

The dock leveler 28 can provide a smooth, safe and efficient transition from the dock 12 to the vehicle 14. Several types of dock levelers are commercially available. One suitable dock leveler is hydraulically powered and commercially available from Rite-Hite Holding Corp. of Milwaukee, Wis. The dock leveler 28 includes a platform 52 that can be raised and lowered. The dock leveler 28 further includes an extendable lip 54. This much of the dock leveler 28 will be understood to be conventional insofar as the present invention is concerned and need not be further described herein. In one example, the dock leveler 28 may have a dock sensor 56 and lip sensor 58. These sensors 56, 58 may indicate a position of the dock leveler 28 and/or the lip 54. The sensors 56, 58 may be optional. In one example the sensors 56, 58 may be limit switches or contact switches.

The dock leveler 28 cannot operate until the door 16 is at its fully opened position (not specifically shown). The door 16 is associated with a door sensor 60 (schematically shown in FIGS. 4-8). Upon complete opening of the door 16, the door sensor 60 provides a signal to the control module 30 that enables the dock leveler 28 for operation. The control panel 26 can be provided with a bypass switch (e.g., a keyed switch) to override, among other things, the need for the door 16 to be at its fully opened position. In one example, a supervisor rather than a door attendant controls the key for the bypass switch.

The dock leveler 28 is movable between a raised position (i.e. level with vehicle 14 and/or suitably aligned with the vehicle 14) and a lowered or home position. The dock leveler 28 can be controlled by a DOCK LEVELER button. In one example a LIP EXTEND button controls deployment of the lip of the dock leveler 28. In another example, the lip is coupled with the dock platform 52 such that movement of the platform 52 causes the lip 54 to extend/retract. On such suitable alignment of the dock leveler 28 with the vehicle 14 that is not otherwise aligned with a bed (not shown) of the vehicle 14 may be referred to as below dock end loading condition. The dock leveler 28 may be positioned to provide access to the bed but not otherwise aligned with the bed. One such situation may include a vehicle with a hydraulic lift coupled to an end of the vehicle. Other situations may include cargo in the bed positioned close enough to an end of the bed that interference with the lip 54 is possible.

In one example, doors 16 and door controllers suitable for use with the teachings of the present invention are commercially available from Advanced Systems, Inc. of Birmingham, Mich. Those skilled in the art, however, will appreciate that alternative doors and door controllers from other sources may also be used in connection with the present invention.

With reference to FIGS. 1 and 2, the operation of the integrated vehicle docking system 10 of the present invention will now be described. When there is no vehicle 14 at the loading dock 12, the vehicle restraint 20 will normally be in its stored position 44 (as shown with respect to the adjacent loading dock 12′ of FIG. 2). Storing of the vehicle restraint 20 normally causes the green light of the outside light unit 22 and the red light of the inside light unit 24 to be turned on. The outside green light can indicate that the loading dock 12 may be approached with a vehicle 14. The inside red light indicates that there is no vehicle parked and suitably secured at the loading dock 12.

To secure a vehicle 14 at the loading dock 12, the vehicle restraint 20 is pulled away from the wall and inserted in front of or adjacent a tire or wheel 62 of the vehicle 14. The lights of the outside light unit 22 immediately change from green to red. After the restraint 20 is in position for a predetermined period of time (e.g., five seconds), the alarm 38 will sound twice indicating that the restraint 20 is in place. Once the restraint 20 has been in position for a predetermined period of time (e.g., fifteen seconds), the blue light of the inside light unit 24 will be turned on and the system 10 will enable operation of the overhead door 16. The inside red light will remain on. Raising of the overhead door 16 can be requested by depressing the DOOR button.

Raising and positioning of the dock leveler 28 can be requested by depressing the DOCK LEVELER button on the control panel 26. Once the dock leveler 28 moves to the aligned and/or suitable position, the lights of the inside light unit will change from red to green. In one example, when the dock leveler 28 is fully raised, the lip will automatically extend. In other examples, the lip 54 may be extended earlier or moved (i.e., when not coupled or based on motion of the platform 52), when the LIP EXTEND button is depressed. By way of the above examples, when the lip 54 is fully extended, the LIP EXTEND button is released and the dock leveler 28 slowly floats down to a bed or platform of the vehicle 14. For below dock end loading (e.g., when the vehicle does not abut the dock 12), the DOCK LEVELER button is depressed until the dock leveler 28 is about six inches above the dock 12. The LIP EXTEND button is depressed until the lip 54 has cleared portions of the dock leveler 28 and then released. The dock leveler 28 will float down for below dock end loading with the lip 54 in a suitable position.

To return the dock leveler 28 to the stored position, the DOCK LEVELER button is depressed. As the leveler 28 raises, the lip 54 will retract. When the lip 54 is fully retracted, the DOCK LEVELER button is released. The leveler 28 will float down to the stored position. When the leveler 28 is stored, the lights of the inside light unit 24 immediately change from green to red.

The door 16 is closed by depressing the DOOR CLOSE button. Once the door 16 is closed, the outside alarm will, for example, sound a short retort every 30 seconds indicating that the vehicle restraint 20 may be removed. To release the vehicle 14 from the loading dock 12, the restraint 20 is removed from its deployed position 46 and returned to its stored position. The lights of the outside light unit 22 will turn from red to green. The light of the inside light unit remains red.

Audible alarms and lights will be activated anytime the vehicle restraint 20 is removed without prior authorization from the dock attendant and/or out of sequence. If the restraint 20 is improperly removed, the alarm will sound continuously until the restraint 20 is replaced to its proper position. It will be appreciated that the alarms, the lights and/or other suitable equipment as described hitherto and throughout may indicate to the vehicle 14 (or driver therein), the dock attendant and/or other suitable users certain conditions of the integrated vehicle docking system 10.

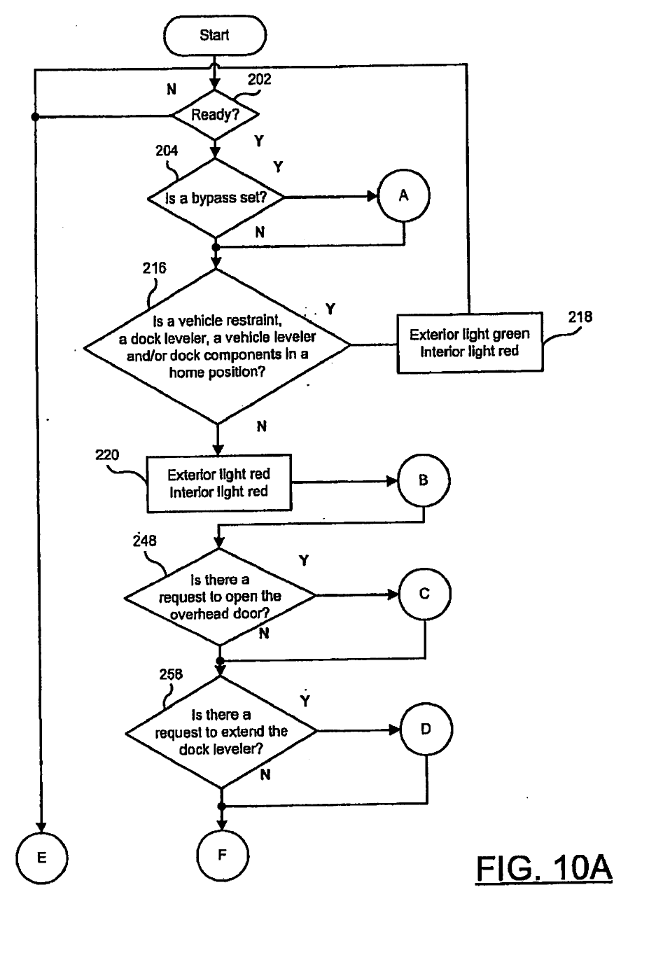

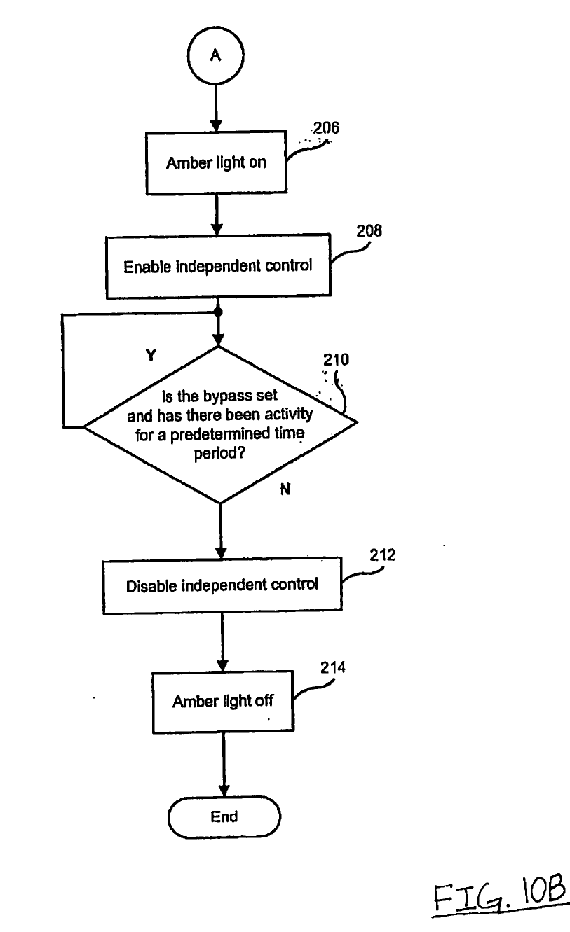

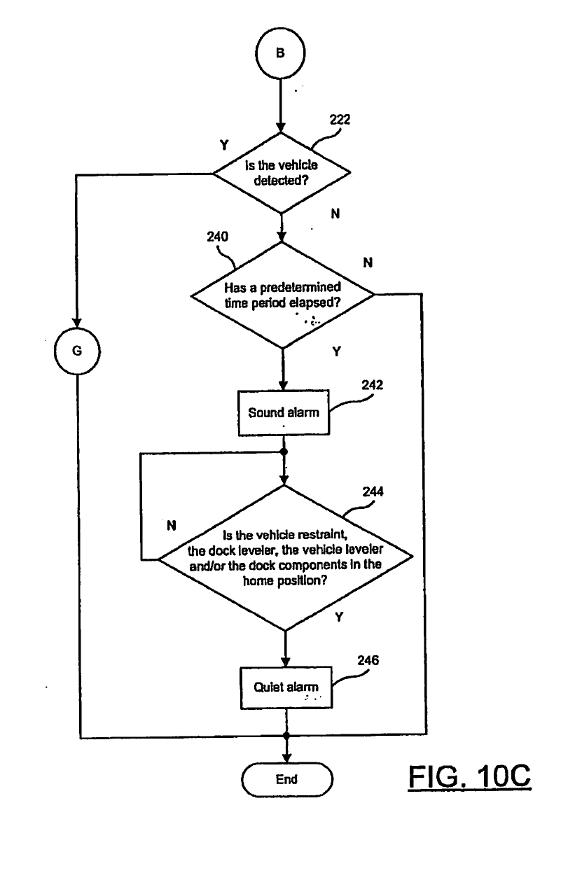

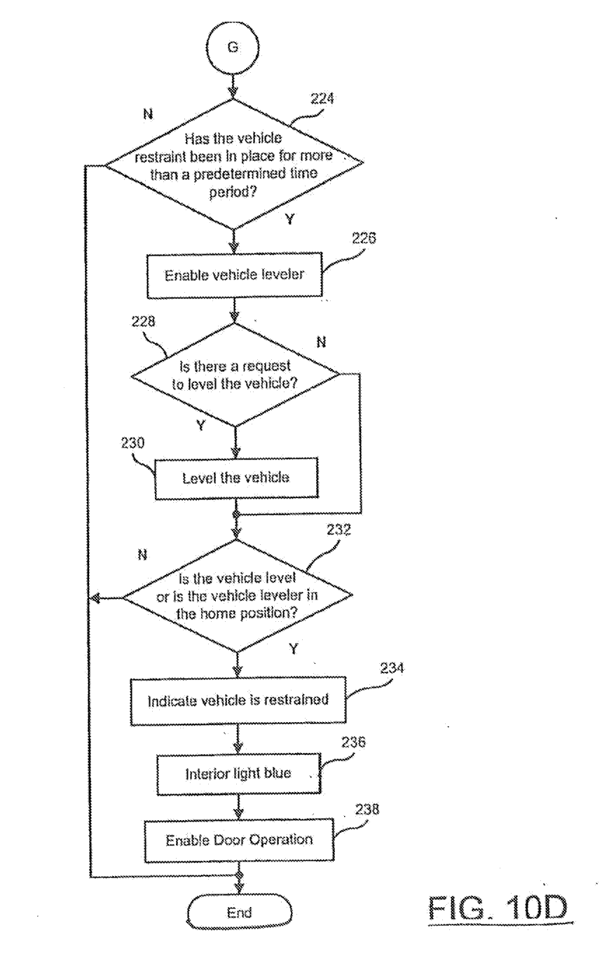

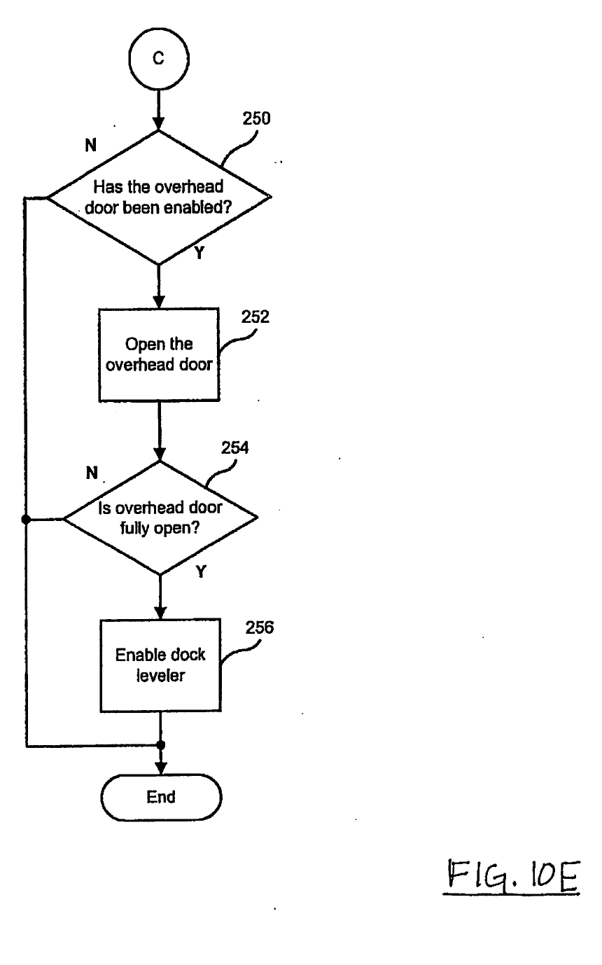

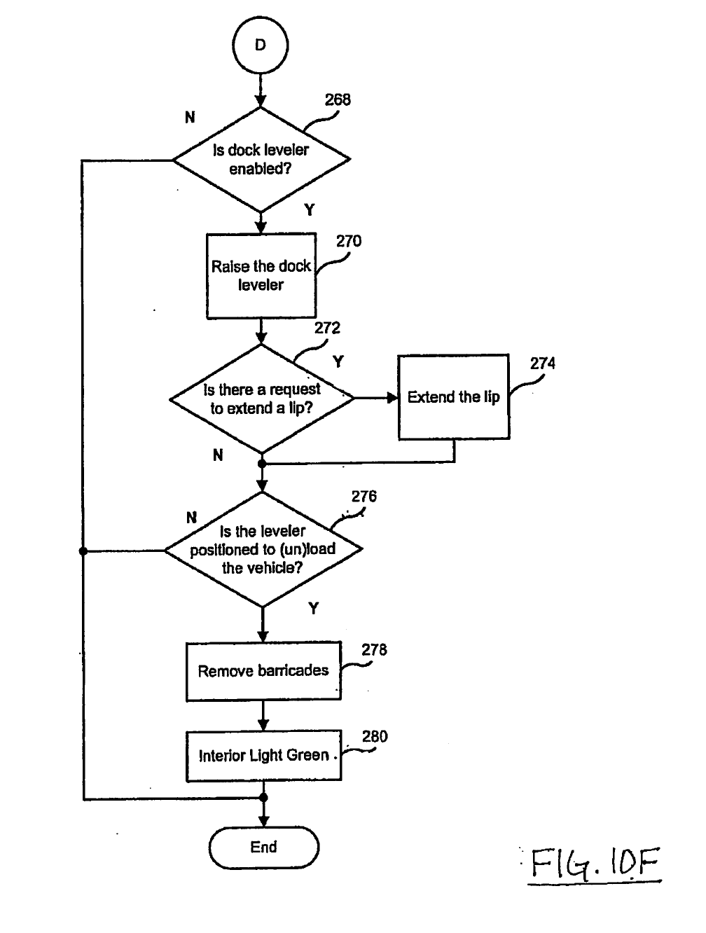

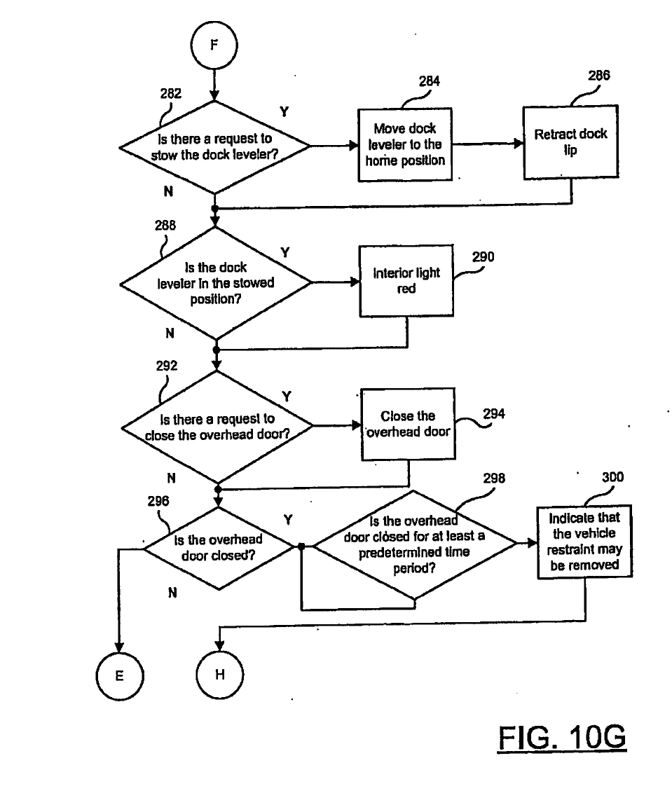

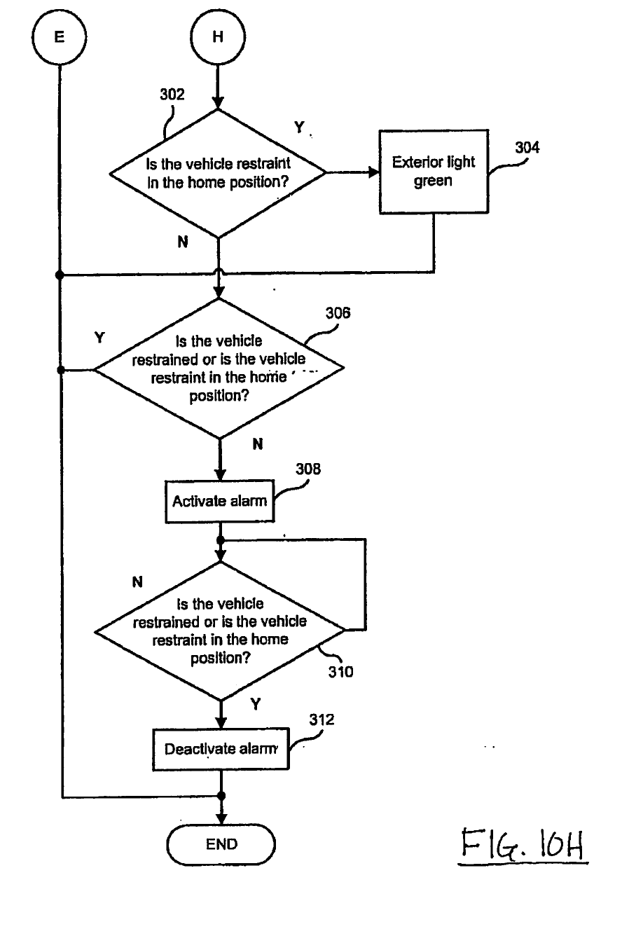

In one example, a control system 100 is illustrated throughout FIGS. 10A-10H, and illustrates an exemplary control and/or sequence implemented by the integrated vehicle docking system 10. In step 202, control determines whether the system is ready. Control may determine the system is ready when the system can communicate with all the sensors and components in the integrated vehicle docking system 10. When control determines whether the system is ready, control continues in step 204. When control determines that the system is not ready, control ends as illustrated in FIG. 10H.

In step 204, control determines whether a bypass is set (e.g., a bypass switch). When control determines that the bypass is set, control continues in step 206. When control determines that the bypass is not set, control continues in step 216. In step 206 and with reference to FIG. 10B, control turns the amber, blue and red lights on of the inside light unit 24 (FIG. 9). In one example, the control flashes one or more of the amber, blue and red lights on of the inside light unit 24. In step 208, control enables independent control.

In step 210, control determines whether the bypass is set and there has been activity in the bypass mode for a predetermined time period. It will be appreciated that the predetermined time period may be about 20 seconds such that control will resume in step 212 after 20 seconds of inactivity. When control determines that the bypass is set and there has been activity in the bypass mode for a predetermined time period, control loops back to step 210. When control determines that the bypass is not set or there has been no activity in the bypass mode for a predetermined time period, control continues in step 212. It will be appreciated that when the bypass remains set, control will loop in step 210 thus maintaining independent control as set in step 208. Independent control, for example, may allow a user to move the various components of the integrated vehicle docking system without described interlocks and safety precautions that have been described hitherto and throughout the disclosure.

In step 212, control disables the independent control. In step 214, control turns off the amber light of the inside light unit 24 (FIG. 9). In step 216 and with reference to FIGS. 2 and 10A, control determines whether the vehicle restraint, the dock leveler 28, the vehicle leveler 36 and/or other suitable dock components are in a home position. When control determines that all of the above components are in the home position, control continues in step 218. When control determines that one or more of the above components are not in the home position, control continues in step 220. In step 218, control turns on the green light in the outside light unit 22 and turns on the red light of the inside light unit 24 (FIG. 9). In step 220, control turns on the red light in the inside and outside light units 22, 24. In step 222 and with reference to FIG. 10C, control determines whether the vehicle 14 is detected.

The vehicle 14 may be detected, for example, by the wheel sensor 32 (FIG. 9). The wheel sensor 32 may determine that the vehicle restraint 28 is placed over or adjacent to the wheel 62. More specifically, the wheel sensor 32 may emit a beam such that when the wheel 62 is placed next to the wheel sensor 32 the beam is interrupted thus indicating that the vehicle restraint 20 is over or adjacent to the wheel sensor 32. In other examples, the wheel sensor 32 may detect various portions of the undercarriage of the vehicle or vehicle trailer 14. The undercarriage may define, but is not limited to, axles, wheels, suspension components, frame members, flanges, other suitable members and combinations thereof. When control determines that the vehicle 14 has been detected, control continues in step 224, as illustrated in FIG. 10D. When control determines that the vehicle has not been detected, control continues in step 240 as illustrated in FIG. 10C.

In step 224 and with reference to FIGS. 9 and 10B, control determines whether the vehicle restraint 20 has been in the deployed position 46 for more than a predetermined period of time. In one example, the predetermined period of time may be five seconds. When control determines that the vehicle restraint 20 has been in the deployed position 46 for more than the predetermined time period, control continues in step 226. When control determines that the vehicle restraint has been in the deployed position 46 for less than the predetermined period of time, control resumes with step 248 as illustrated in FIG. 10A.

In step 226 and with reference to FIGS. 9 and 10D, control enables the vehicle leveler 36. In step 228, control determines whether there has been a request to level the vehicle 14 (e.g., pressing the VEHICLE LEVELER button). If there has been a request to level the vehicle 14, control continues in step 230. If control determines there has not been a request to level the vehicle 14, control continues in step 232. In step 230, control levels the vehicle 14 with the vehicle leveler 36. In step 232, control determines whether the vehicle is level or whether the vehicle leveler is in the home position. When control determines that the vehicle is neither level nor is the vehicle leveler in the home position, control continues in step 248 as illustrated in FIG. 10A. When control determines that the vehicle is level or that the vehicle leveler is in the home position, control continues in step 234. In step 234, control indicates that the vehicle 14 is restrained (and optionally that the vehicle 14 is leveled). In one example, control indicates that the vehicle is restrained by sounding an outside alarm twice. In step 236, control turns on the blue light in the inside light unit 24. In step 238, control enables operation of the overhead door 16.

In step 240 and with reference to FIG. 10C, control determines whether a predetermined time has elapsed. In one example, a predetermined time period is about 20 seconds. When control determines that a predetermined time period has elapsed, control continues in step 242. When control determines that a predetermined time period has not elapsed, control continues in step 248 as illustrated in FIG. 10A. In step 242, control sounds an alarm. In step 244, control determines whether the vehicle restraint, the dock leveler, the vehicle leveler and/or other suitable dock components are in the home position. When control determines that the above components are in the home position, control continues in step 246. When control determines that the above components are not in the home position, control loops back to step 244. It will be appreciated that control loops at step 244 until the above described components are in the home position and thus continually sounds the alarm. In step 246, control quiets the alarm.

In step 248 and with reference to FIGS. 9 and 10A, control determines whether there is a request to open the overhead door 16 (i.e., pressing the DOOR button). When control determines that there is a request to open the overhead door 16, control continues with step 250 as illustrated in FIG. 10E. When control determines there is not been a request to open the overhead door, control continues in step 258, as illustrated in FIG. 10A.

In step 250 and with reference to FIGS. 9 and 10E, control determines whether the overhead door 16 has been enabled. When control determines that the overhead door 16 has been enabled, control continues in step 252. When control determines that the overhead door 16 has not been enabled, control continues in step 258 as illustrated in FIG. 10A. In step 252, control opens the overhead door 16. In step 254, control determines whether the overhead door 16 is fully open. When a control determines that the overhead door 16 is fully open, control continues in step 256. When control determines that the overhead door is not fully open, control continues in step 258, as illustrated in FIG. 10A. In step 256, control enables the dock leveler 28.

In step 258 and with reference to FIGS. 9 and 10A, control determines whether there is a request to extend the dock leveler (e.g., pressing DOCK LEVELER button). When control determines that there is a request to extend or raise the dock leveler, control continues in step 260, as illustrated in FIG. 10F. When control determines that there is no request to extend the dock leveler, control continues in step 282, as shown in FIG. 10G.

In step 268 and with reference to FIGS. 9 and 10F, control determines whether the dock leveler 28 is enabled. When control determines that a dock leveler 28 is not enabled, control continues in step 282, as shown in FIG. 10G. When the control determines that a dock leveler is enabled, control continues in step 270. In step 270, control raises or extends the dock leveler 28. In step 272, control determines whether there is a request to extend a lip 54 (e.g., pressing the LIP EXTEND button). When control determines that there is a request to extend the lip 54, control continues in step 274. When control determines there is not a request to extend the lip 54, control continues in step 276. In step 274, control extends the lip 54. It will be appreciated that in some examples, the lip 54 is mechanically coupled with the dock leveler 28 such that raising or extending of the dock leveler 28 raises or extends the lip 54. In other examples, the lip 54 may be independently actuated relative to the dock leveler 28 and/or platform 52.

In step 276, control determines whether the dock leveler 28 is positioned to load (or unload) the vehicle 14. When a control determines that the dock leveler 28 is positioned to load (or unload) the vehicle 14, control continues in step 278. When the control determines that the leveler is not positioned to load (or unload) the vehicle 14, control continues in step 282, as shown in FIG. 10G. In step 278, control removes barricades. In one example, the barricades may prevent access to the vehicle 14 when the door 16 is open and the dock leveler 28 is not in the proper position. It will be appreciated that barricades or other similar items are optional. In step 280, control turns on the green light of the inside light unit 24.

In step 282 and with reference to FIGS. 9 and 10G, control determines whether there is a request to stow the dock leveler 28 (e.g., press DOCK LEVELER button). When control determines that there is a request to stow the dock leveler 28, control continues in step 284. When control determines there is not a request to stow the dock leveler 28 control continues in step 288. In step 284, control moves the dock leveler 28 to the home position. In step 286, control retracts the lip 54. It will be appreciated that in the example where the dock lip is mechanically coupled (i.e., dependent) upon movement of the dock leveler 28, there is no need to independently retract the lip 54. As such, step 286 may be optional.

In step 288, control determines whether the dock leveler 28 is in the stowed position. When control determines that the dock leveler 28 is in the stowed position, control continues in step 290. When control determines that the dock leveler 28 is not in the stowed position, control continues in step 292. In step 290, control turns on the red light of the inside light unit 22. In step 292, control determines whether there is a request to close the overhead door 16 (e.g., press the DOOR button). When control determines that there is a request to close the overhead door 16, control continues in step 294. When control determines that there is not a request a request to close the overhead door 16, control continues in step 296. In step 294, control closes the overhead door 16.

In step 296, control determines whether the overhead door 16 is closed. When control determines that the overhead door 16 is closed, control continues in step 298. When a control determines that the overhead door 16 is not closed, control ends, as illustrated in FIG. 10H. In step 298 and with reference to FIGS. 9 and 10G, control determines whether the overhead door 16 has been closed for at least a predetermined period of time. In one example, the predetermined period of time may be about twenty seconds. When control determines that the overhead door 16 has been closed for at least the predetermined period of time, control continues in step 300. When control determines that the overhead door 16 has not been closed for at least a predetermined period of time, control loops back to step 298. It will be appreciated that control loops at step 298 until the overhead door 16 has been closed for at least a predetermined period of time.

In step 302 and with reference to FIGS. 9 and 10H, control determines whether the vehicle restraint 20 is in the home or stowed position 44. When control determines that the vehicle restraint 20 is in the home position 44, control continues in step 304. When control determines that the vehicle restraint 20 is not in the home position 44, control continues in step 306. In step 304, control turns on the green light in the outside light unit 22. From step 304, control ends.

In step 306, control determines whether the vehicle 14 is restrained or whether the vehicle restraint 20 is in the home position 44. When control determines that the vehicle 14 is neither restrained nor is the vehicle restraint in the home position 44, control continues in step 308. When control determines that either the vehicle 14 is restrained or the vehicle restraint is in the home position 44, control ends.

In step 308, control activates an alarm. In step 310, control determines whether the vehicle 14 is restrained or whether the vehicle restraint 20 is in the home position 44. When control determines that neither the vehicle 14 is restrained nor the vehicle restraint 20 is in the home position 44, control loops back with step 310. When control determines that the vehicle 14 is restrained or the vehicle restraint 20 is in the home position 44, control continues in step 312. It will be appreciated that control loops at step 310 and thus continues to activate the alarm when the vehicle 14 is neither restrained nor the vehicle restraint is in the home position 44. In step 312, control deactivates the alarm. From step 312, control ends.

In one example, the control panel 32 may include a stop button (not specifically shown) that may be activated to cease all movement of the integrated vehicle docking system 10. Activation of the stop button (e.g., pulling the stop switch) may cease all movement, while deactivation of the stop button (e.g., pushing the stop switch) may continue motion of the various components of the dock system 10 (e.g., the dock leveler 28).

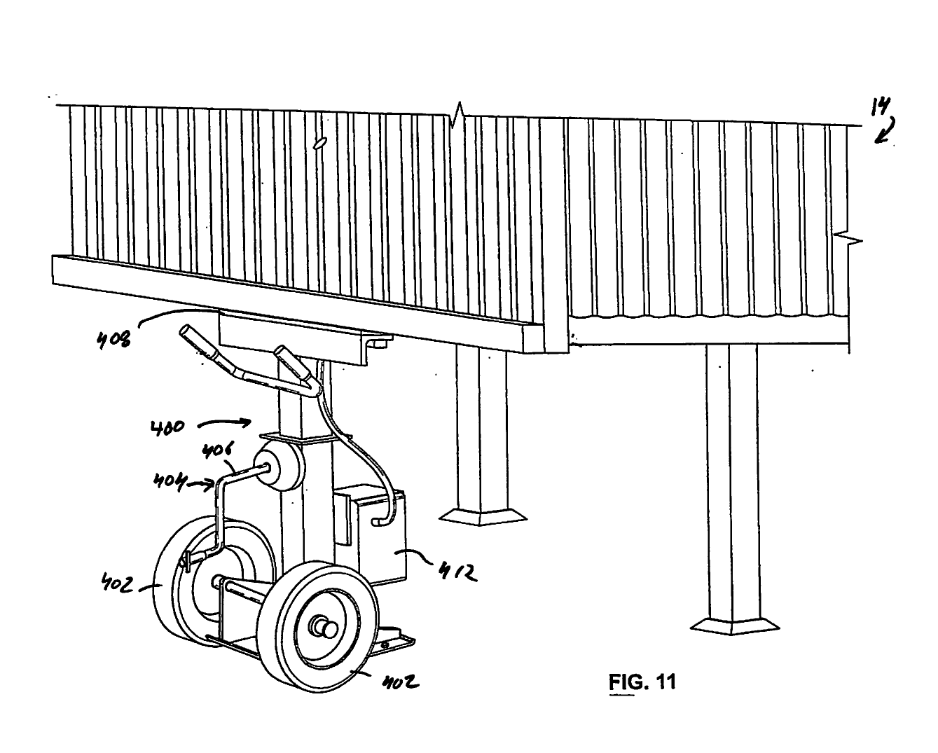

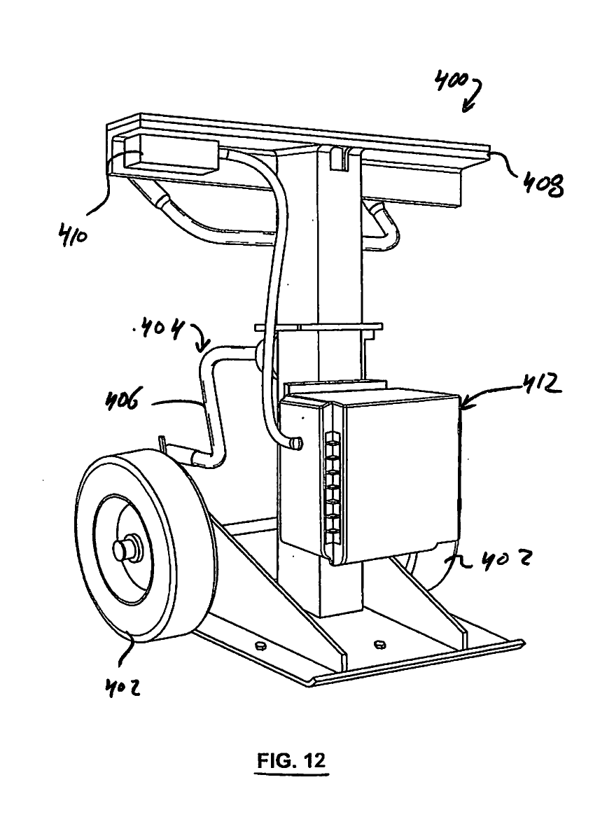

Turning to FIGS. 11 and 12, a trailer jack or use with a docking system 10 in accordance with the present teachings is illustrated and identified a reference character 400 FIG. 11 illustrates the trailer jack 400 operatively associated with the trailer. To the extent not otherwise described herein, it will be understood that the physical constraint of the trailer 14 with the trailer jack 400 is conventional. It will further be understood that the mechanical structure of the trailer jack 400 is not critical to the present teachings. In this regard, other types of trailer jacks may be employed provided that they are adapted according to the present teachings.

The trailer jack 400 may be a portable device. To this end, the trailer jack 400 may include a plurality of wheels 402. As illustrated, the trailer jack 400 may include two wheels 402.

The trailer jack 400 may include an arrangement 404 for engaging and restraining the trailer 14. The arrangement 404 may include a crank 406 or other control device for manually or electronically moving a trailer engaging element 408. As illustrated, the crank 406 may be operated in a first direction to raise the trailer engaging element 408 and a second direction for lowering the trailer engaging element 408.

A sensor 410 may be carried by the trailer engaging element 408. The sensor 410 may be operative to sense engagement of trailer jack 400 with the trailer 14. In this regard, the sensor 410 may be operative to sense proper restraint of the trailer 14 by the trailer jack 400. The sensor 410 may include a pressure sensor or any other type of known sensor.

A control unit 412 may be carried by the trailer jack 400 and may be in electrical communication with the sensor 410. The control unit 412 may be operative to generate a signal in response to positive sensing by the sensor 410. The control unit 412 may be further operative to transmit the signal to the control panel 26. As illustrated, the control unit 412 is operative to remotely transmit the signal to the control panel 26 in a wireless manner. In other applications, however, the signal can be send through a wire.

The control module 30 of the system 10 may operate to enable operation of a trailer access device in response to receiving the signal from the trailer jack 400 indicating restraint of the trailer 14. The trailer access device may be selected from a group including the overhead door 16, the dock leveler 28, and a vehicle leveler 36. The control module 30 may also function to generate an audible communication signal upon receipt of the signal from the trailer jack 14.

Accordingly, an arrangement is provided that improves safety by eliminating human error. In this regard, an arrangement is provided in which a trailer jack 400 must be properly engaged with a vehicle trailer 14 before access to the vehicle trailer 14 from the loading dock 12 is provided. Through integration of the trailer jack 400 into the sequential requirements in the control panel 26, door and dock operation cannot continue unless the trailer 14 is properly stabilized by the trailer jack 400. Should the trailer jack 400 be prematurely removed, the control module 30 may operate to activate audible and/or visual alarms to notify personnel of the situation.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A method for controlling a docking system that receives a vehicle trailer at a loading dock, the method comprising:
Providing a trailer jack;
engaging the vehicle trailer when the vehicle trailer is at the loading dock with a trailer jack;
sensing when the vehicle is restrained by the vehicle trailer with a sensor carried by the vehicle trailer;
enabling operation of a trailer access device in response to sensing by the sensor to permit access to the loading dock.

2. The method of claim 1, further comprising generating a signal indicative of positive restraint of the vehicle trailer by the trailer jack in response to sensing by the sensor.

3. The method of claim 2, further comprising controlling operation of the trailer access device in response to the signal.

4. The method of claim 1, wherein the sensor is a pressure sensor.

5. The method of claim 1, wherein the trailer jack includes a moveable element carrying the sensor and engaging the vehicle trailer includes moving the moveable element.

6. The method of claim 2, further comprising remotely transmitting the signal to a control unit.

7. The method of claim 1, further comprising remotely and wirelessly transmitting the signal to a control unit.

8. A method for controlling a docking system for providing access to a vehicle trailer at a loading dock, the method comprising:
automatically detecting the vehicle trailer at the loading dock;
automatically determining whether the vehicle trailer is restrained based on the detection; and
automatically enabling operation of a trailer access device based on the determination;
wherein detecting the vehicle trailer includes sensing restraint of the vehicle trailer by a sensor carried by a trailer jack and generating a signal indicative of the sensing.

9. The method of claim 8, wherein the trailer access device is selected from a group including a dock leveler, a trailer leveler and a dock access door.

10. The method of claim 8, further comprising controlling operation of the trailer access device in response to the signal.

11. The method of claim 8, wherein the sensor is a pressure sensor.

12. The method of claim 8, wherein the trailer jack includes a moveable element carrying the sensor and engaging the vehicle trailer includes moving the moveable element.

13. The method of claim 8, further comprising remotely transmitting the signal to a control unit.

14. The method of claim 8, further comprising remotely and wirelessly transmitting the signal to a control unit.

15. A vehicle trailer docking system that receives a vehicle trailer at a loading dock, the system comprising:
means for sensing when the vehicle is restrained by the vehicle trailer, means for generating a signal indicative of positive restraint, and means for remotely transmitting the signal to the control unit;
a trailer access device adapted to permit access to the trailer from the loading dock;
a control module for controlling access to the trailer access device; and
a trailer jack including a sensor that detects the trailer at the loading dock;
a trailer access device adapted to permit access to the trailer from the loading dock; and
a control module for controlling access to the trailer access device; and
whereby the control unit automatically operates to permit access to the trailer from the loading dock in response to the signal.

16. The system of claim 15, wherein the trailer access device is selected from a group including a dock leveler, a trailer leveler and a dock access door.

17. The system of claim 15, wherein the means for sensing is a pressure sensor.

18. The system of claim 17, wherein the trailer jack includes a moveable element carrying the pressure sensor.

19. The system of claim 15, wherein the means for remotely transmitting is operative to wirelessly transmit the signal.
